(19) United States
(12) Patent Application Publication
(10) Pub. No.: US 2009/0015371 A1
(43) Pub. Date: Jan. 15, 2009

(54) SYSTEM AND METHOD OF CONTROLLING ACCESS TO SERVICES

(76) Inventors: Xavier Bocquet, Vence (FR); Franck Boudinet, Villeneuve-Loubet (FR); Didier Decroos, Nice (FR); Pierre Secondo, Tourrettes sur Loup (FR)

Correspondence Address: HOFFMAN WARNICK LLC, 75 STATE ST, 14 FL, ALBANY, NY, 12207, US

(21) Appl. No.: 12/136,252

(22) Filed: Jun. 10, 2008

(30) Foreign Application Priority Data
Jul. 10, 2007 (EP) 07301222.1

(51) Int. Cl. H04L 9/32

(52) U.S. Cl. 340/5.2

(57) ABSTRACT

The subject matter described herein generally relates to methods and systems for controlling access to services and more specifically relates to a method and a system for controlling access to a variety of services within security sensitive sites. In one embodiment, the invention provides a system for controlling access to a plurality of services within an area, each service of the plurality of services being associated with a service identifier identifying the service, the system comprising: at least one service device storing a service identifier for identifying a service among the plurality of services, each service device covering a proximity zone within the area and being capable of activating the service identifier stored by the service device for the user, in response to the detection of a user in the proximity zone; and an access control subsystem to control the access of a user to a service identified by a service identifier activated for the user.

### CROSS-REFERENCE TO RELATED APPLICATIONS

This application claims the benefit of co-pending European Patent Application No. EP07301222, filed 10 Jul. 2007, which is hereby incorporated herein.

### FIELD OF THE INVENTION

The subject matter described herein generally relates to methods and systems for controlling access to services and more specifically relates to a system, device, and method for controlling access to a variety of services within security sensitive sites, such as pharmaceutical laboratories, chemical plants, nuclear station plants, etc.

### BACKGROUND OF THE INVENTION

A general concern in security sensitive sites is to provide a level of protection that is sufficient, yet not complex for the employees. In particular, there is a necessity to secure access to high risk services that might have harmful effects for the individuals present in the site or around the site, and for the environment. As is known, the level of risk while accessing such services can be all the more important as the employee or visitor is localized in a dangerous zone of the site, and therefore access to some services needs to be restricted depending not only on the nature of the service but also on local conditions.

For instance, in a confined area of a pharmaceutical laboratory site, care should be taken to ensure that only experienced physicians are allowed to open cases containing biological samples. Accordingly, the security rules to apply for controlling access to a service should take into account the level of local risks in the area, the level of risks related to the service, and the level of authorization of the user who requires access to the service.

A known solution to ensure that only authorized users could have access to a service in high risk zones is to provide human safe guards in the entrance of such zones or door-based access control systems. However, providing human guards at various locations within the site is generally impractical and unaffordable. As for door-based access control systems, they generally only control a few zones independent of the nature of the service to be used, using complex approaches based on identification systems and passwords. As an example of a complex approach, there exist solutions for which employees have to input identification data through an interface controlling the access to a zone closed by a security door. Such approaches require that several security doors be provided within the site, thus defining a plurality of controlled zones. On top of being complex, such approaches involve important costs and require too much time for identification. Further, shutting certain zones would disable certain users from physically accessing zones when they actually do not intend to use a service in these zones, or access to dangerous services. The solutions of the prior art thus only allow or deny access to a controlled zone independently of whether a service is to be used in the area and of the nature of the service. They are also reliant on guards to be present or on authorized people keeping the doors closed after entering the controlled zones.

The present invention overcomes the problem of conventional systems as will be described in greater detail below.

### SUMMARY OF THE INVENTION

In view of the foregoing and other exemplary problems, drawbacks, and disadvantages of the conventional systems and methods, an embodiment of the present invention provides a system for controlling access to a plurality of services within an area, each service of the plurality of services being associated with a service identifier identifying the service, the system comprising: at least one service device storing a service identifier for identifying a service among the plurality of services, each service device covering a proximity zone within the area and being capable of activating the service identifier stored by the service device for the user, in response to the detection of a user in the proximity zone; and an access control subsystem to control the access of a user to a service identified by a service identifier activated for the user.

Another embodiment of the invention provides a device for interacting with a system for controlling access to a plurality of services within an area, the device comprising: storage means for storing a user equipment identifier and being capable of storing at least one service identifier received from a service device, in response to the activation of the service identifier by the service device.

Another embodiment of the invention provides a method for controlling access to a plurality of services within an area, each service of the plurality of services being associated with a service identifier identifying the service, the method comprising: providing at least one service device for storing a service identifier identifying a service among the plurality of services, each service device covering a proximity zone within the area; in response to the detection of a user in the proximity zone of a service device, activating the service identifier stored by the service device for the user; and in response to a service identifier being activated for a user located in the area, controlling access of the user to the service identified by the activated service identifier.

Still other embodiments of the invention provide a system and a method that obviate the needs for guards, control-based door infrastructures, or complex identification devices. To request access to a service a user will only have to be equipped with a user equipment, according to the invention, to come close to the service support and wait for an authorization token to be provided.

Embodiments of the invention ensure control of access to services available in a security sensitive area, taking into account the local conditions, the level of risk inherent to the service, and the level of authorization of the user, in a transparent and dynamic manner.

Further advantages of the present invention will become clear to the skilled person upon examination of the drawings and detailed description. It is intended that any auxiliary advantages be incorporated herein.

### BRIEF DESCRIPTION OF THE DRAWINGS

Embodiments of the present invention will now be described by way of non-limiting example with reference to the accompanying drawings in which like references denote similar elements. In the drawings:

FIG. 1 shows a block diagram of an access control system, according to the invention;

FIG. 2 depicts a user equipment according to the invention;

FIG. 3 illustrates the interactions between a user equipment and a service device, according to the invention;

FIG. 4 illustrates the interactions between a user equipment and a service device, according to an exemplary embodiment of the invention;

FIG. 5 is a flowchart showing the steps performed by a service device for activating a service identifier;

FIG. 6 illustrates the interactions between a user equipment and location means, according to the invention;

FIG. 7 depicts location means according to an exemplary embodiment of the invention;

FIG. 8 illustrates the interactions between a user equipment and a receiver, according to an exemplary embodiment of the invention;

FIG. 9 shows the steps performed by the access control subsystem when a user equipment is detected in the area;

FIG. 10 is a block diagram of a service support according to the invention;

FIG. 11 shows an example of an authorization table; and

FIG. 12 shows an example of data exchange between the components of the system according to the invention.

### DETAILED DESCRIPTION

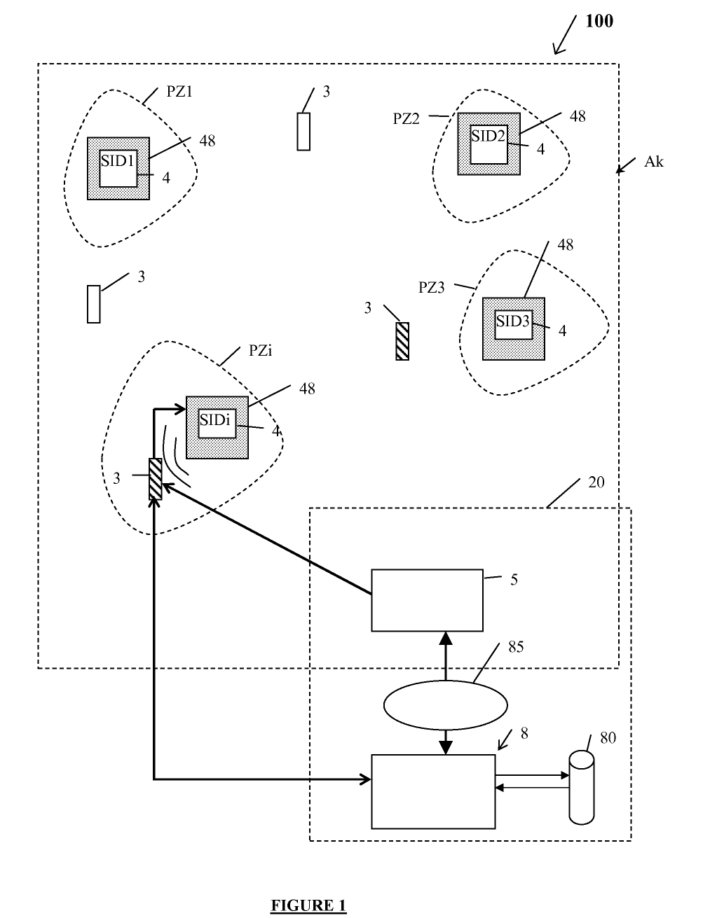

Referring first to FIG. 1, there is provided an access control system 100 for controlling access to services in a security sensitive area Ak within a site, such as for example a pharmaceutics laboratory, a chemical plant, a gasoline station, a nuclear station plant, etc. As would be evident to one of ordinary skill in the art, the invention is not limited to the above exemplary sites, and indeed can be practiced in many different environments and applications.

A security sensitive area Ak is a part of the site in which there exist risk conditions. Throughout the area Ak, the risk conditions may vary for each available service. Thus, for a given service, area Ak may contain zones where the level of risk is low, and zones where the level of risk is increased. For example, in a pharmaceutical laboratory site, an example of a security sensitive area could be a confined area, like a room, in which the level of risk is high for a service consisting in opening an enclosure containing contaminated biological samples, while the level of risk outside the room is low for the same service. In area Ak, users, such as for instance employees or visitors, may freely move and try to access to a plurality of available services.

Here, the word “service” should be understood as having a broad meaning, encompassing a number of actions that users may perform within the site, like for example the opening of the enclosure as mentioned above. For example, in a gasoline station site, the service could consist of using particular equipment, in an area where flammable steam, like a gas fume, might be present, or in a chemical plant site, the service could consist of manipulating special substances in an area containing local substances that could have an explosive reaction with the manipulated substances.

Therefore, the expression “accessing a service” should be understood as encompassing access to equipment and resources as well.

Each available service in the area comprises a service support 48 that may be fixed or mobile in the area. The service support 48 may include a service locking mechanism to electronically or mechanically enable or disable access to the service.

It should be noted that the term “security-sensitive area”, in the context of the present invention, refers to an area with dimensions than can span throughout the site or be limited to a particular region of the site. In particular, the site may include several security sensitive areas Ai, Aj, etc.

As shown in FIG. 1, system 100 comprises a number of service devices 4 arranged in area Ak to control access to a plurality of available services, whether fixed or mobile. Each service device 4 is associated with a given service among the plurality of services that are available within the area Ak. Each service device 4 is in particular of small size and is arranged on the service support 48. In the example consisting in opening an enclosure containing contaminated biological samples, the service support 48 could be for instance the enclosure.

To request access to a particular service, a user equipped with a user equipment 3, comes in close proximity to the corresponding service device 4. The service device 4 is provided to “activate” or “awake” a service identifier SID identifying the service for the user, when the user is detected in close proximity to the service.

The service device 4 may “activate” or “awake” the service identifier SID for the user by tagging the user equipment 3, worn by the user, with the service identifier SID. To tag the user equipment, the service device 4 may in particular write the service identifier to the user equipment 3. The users for which a service identifier has been activated will be designated thereinafter as “tagged users”.

System 100 of the invention further comprises an access control subsystem 20 to control whether a “tagged” user, in area Ak, should be granted access to the service identified by the activated service identifier SID.

More specifically, the access control subsystem 20 is provided to detect the presence of a “tagged” user within the security sensitive area Ak, and to determine an authorization token. The final decision to grant or deny the user access to the service will be made on the basis of the authorization token.

The access control subsystem 20 uses the service identifier SID, a user related identifier UID identifying the tagged user, and location data related to the position Pi of the user in the area Ak to compute the authorization token. The authorization token will be used to decide whether the user should be granted access to the service identified by the activated service identifier SID.

The access control subsystem 20 comprises location means 5 to detect the presence of the user within the security sensitive area Ak and to determine the location data LD related to the position of the user within the area Ak.

The access control subsystem 20 further comprises a processing unit 8 that computes the authorization token based on the activated service identifier SIDi, the location data LD, and the identifier related to the user UIDi. The access control subsystem 20 further includes a database 80 storing at least one authorization table. The processing unit 8 interacts with the database 80 to compute the authorization token. One skilled in the art will understand that the database 80 could alternatively be incorporated in the processing unit 8.

Accordingly, each area Ak within the site may include, on the one hand, a number of fixed or mobile service devices 4 for service identifiers activation, and on the other hand, location means 5 and a processing unit 8 coupled to database 80, for controlling access to services. Alternatively, a unique processing unit 8 coupled to database 80 could be used in common for several separate areas.

The invention thus makes it possible to dynamically and transparently ensure security in high risk areas within a site. The authorization token computed according to the invention for a given user and a given service is representative of a risk context. This risk context takes into account local risk conditions, the level of risk related to the service, and the level of authorization of the user.

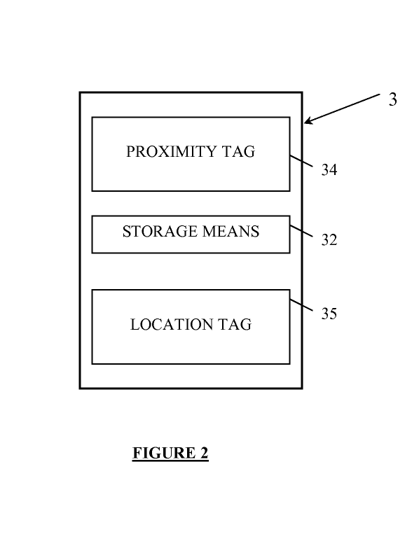

The users, e.g., employees or visitors, who are likely to need access to services available within a security sensitive area Ak have to be provided with, or carry, or wear, a user equipment (a device) 3 mounted for example in a plastic carrier, such as a picture identification card, a badge, a wrist band, a clip, a pin, etc. FIG. 2 depicts a user equipment 3 according to the invention.

Each user equipment 3 comprises a location tag 35 that cooperates with the location means 5, a proximity tag 34 that cooperates with the service devices 4, and storage means 32 for storing information specific to the user and to the services. The location tag 34 and the proximity tag 35 may share information through storage means 32. Alternatively, system 100 could include two separate storage means for the location tag 34 and the proximity tag 35. In this alternative, the user equipment 3 would have to be equipped with exchange means for information exchange between the proximity tag 34 and the location tag 35.

The information stored in the storage means 32 includes, with no limitation, an identifier related to the user. For instance, the identifier UID may be an equipment identifier, in the form of a serial number, identifying the user equipment 3. The identifier related to the user will be described hereinafter as an equipment identifier, for example purposes only.

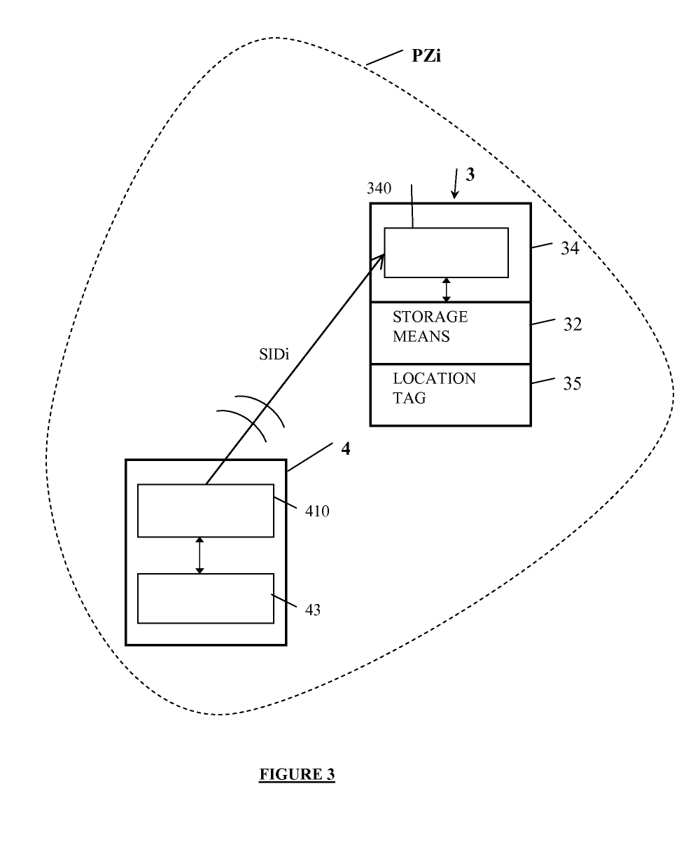

Reference is now made to FIG. 3 representing a service device 4 in communication with the user equipment 3. Each service device 4 associated with a service “i” is equipped with storage means 43 for storing a service identifier SIDi identifying service “i”, and with proximity communication means 410 to cover a proximity zone PZi within the area Ak.

The term “proximity zone” in the context of the present invention refers to typical distances, ranging from few centimeters up to several meters depending on the type of service. The proximity zone coverage should be chosen in order to avoid that a user intending to use a first service could not activate by error the service identifier of a second service device located close to the first service device. In some exemplary situations, when service supports 48 are located adjacent to each other, the proximity zone coverage could be restricted in such a way that a user intending to use a given service will have to bring his user equipment 3 in close contact with the corresponding service device 4, to activate the service identifier.

The proximity tag 34 comprises communication means 340 paired with the proximity communication means 410 of the service device 4 for communication between the proximity tag 34 and the service device 4. More specifically, the service device 4 is adapted to detect the presence of a user equipment 3 within the proximity zone PZi and to establish communication with the proximity tag 34 of a detected user equipment 3.

When the communication is established, the service device 4 tags the user equipment 3 with the service identifier SIDi stored in the storage means 43, thereby “awaking” or “activating” the service identifier SIDi.

To tag the user equipment, the service device 4 may transmit the service identifier SIDi to the location tag 34 through the established communication. The location tag 34 will in turn store the activated service identifier SIDi in the storage means 32 of the user equipment 3.

Accordingly, users, for instance employees or visitors, have simply to be equipped with a badge, wristband, etc. containing the user equipment 3 and to move close to a service device 4 provided on a service support 48 in the security sensitive area Ak in order to request access to the service associated with the service device. This will trigger “activation” of the service identifier SIDi attached to the requested service for that user, and subsequently service access control, in a transparent and dynamic manner.

The technology used for the proximity communication means 410 will depend on the desired coverage of the proximity zones PZi. In particular, the proximity communication means 410 may be wireless or non-wireless short-range communication means, like for instance communication means of the type RFID (radio frequency identification), Bluetooth, NFC (Near Field Communication) or infrared. The short-range communication means could be of contactless or contact type. As an example of contact type communication means, the user equipment 3 could be implemented in the form of a contact smart card for insertion in a control slot provided in the service support 48.

As would be evident to one of ordinary skill in the art, the invention is not limited to the above exemplary proximity communication means, and indeed may include any type of communication means adapted to define the desired proximity zone coverage.

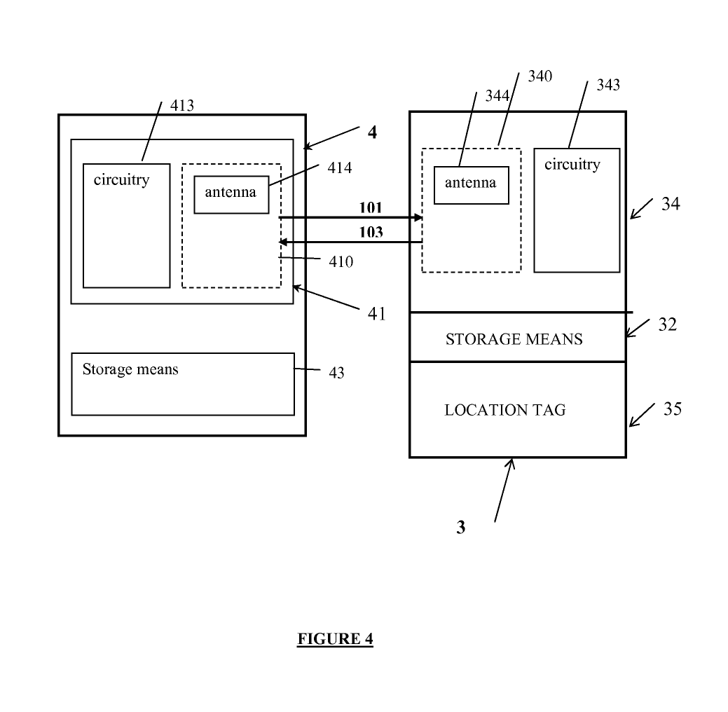

In one exemplary embodiment illustrated at FIG. 4, the proximity communication means use radio frequency identification (RFID).

The proximity communication means will be described below as RFID communication means, for example purposes only. According to this embodiment, each service device 4 includes a radio frequency identification (RFID) interrogator 41 incorporating the RFID proximity communication means 410. The proximity tag 34 is a radio frequency identification (RFID) tag or transponder interacting with the RFID interrogator 41.

The interrogator 41 is capable of interrogating at least one RFID proximity tag 34 detected in the proximity zone PZi of service device 4. Alternatively, the interrogator 41 could interrogate more than one proximity tags 34 detected in the proximity zone PZi, e.g. in applications where more than one user may access simultaneously to a same service. When communication is established, the interrogator 41 of the RFID service device 4 and the RFID proximity tag 34 exchange radio frequency signals.

The communication range of the RFID interrogator 4 is set to define the desired size of the proximity zone PZi. As shown in FIG. 4, the RFID interrogator 41 comprises a suitable circuitry 413 and the proximity communication means 410. The proximity communication means 410 include an antenna 414 capable of bi-directional communication or coupling, according to a desired communication protocol, with RFID proximity tag 34, when tag 34 is detected in the proximity zone PZi.

The proximity tag 34 includes suitable RFID circuitry 343 and the communication means 340. Communication means 340 includes an antenna 344 to receive RF interrogation communication 101 from the interrogator 41 and transmit a suitable RF response communication 103 to the interrogator 41.

In one exemplary aspect of the invention, the RFID circuitry 343 of the proximity tag 34 is “passive”. Accordingly, the RFID passive tag 34 derives the energy needed to power the tag from the interrogating radio frequency field transmitted by interrogator 41, and uses that energy to transmit response back to the interrogator 41 via antenna 414.

Alternatively, the RFID circuitry 343 of tag 34 may be “active” (i.e. capable of actively generating the RF response communication 103). The active tag 34 incorporates an additional energy source, such as a battery, into the tag construction. This energy source permits the active RFID tag 34 to create and transmit strong response signals even in regions where the interrogating radio frequency field is weak.

The proximity tag 34 will be described hereinafter as a passive tag, for example purposes. However, those skilled in the art will recognize that other types of RFID tags could also be used. The antenna 414 of the interrogator 41 transmits electromagnetic energy 101 to the antenna 344 of the RFID proximity tag 34, upon detection of the user equipment 3 in the proximity zone PZi. This powers up the RFID circuitry 343 of the proximity tag 34 and allows it to produce the electromagnetic return signal 103, as shown. The RFID proximity tag 34 is of read/write type so that the interrogator 41 can write the service identifier SIDi retrieved from the storage means 43 to the RFID proximity tag 34, whereby activating the service identifier SIDi for the user.

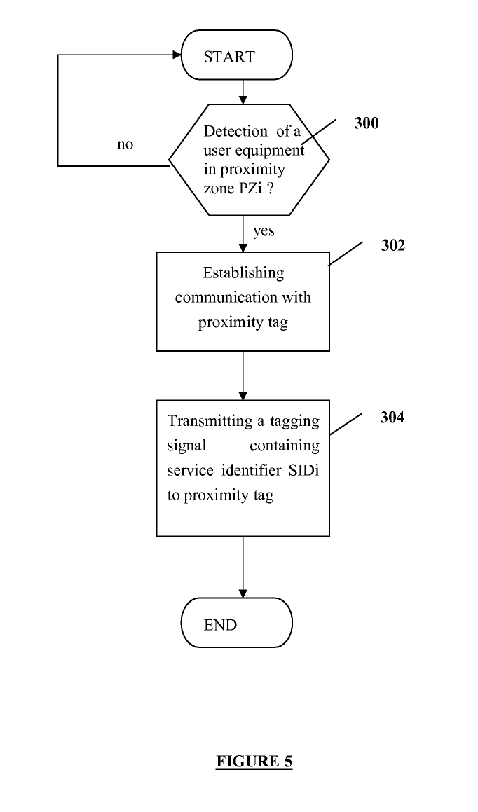

FIG. 5 is a flowchart illustrating the steps performed by the service device 4 to activate a service identifier, according to the present invention. The service “activation” method according to the invention begins at step 300, when a user in possession of a user equipment 3 is detected in the proximity zone PZi covered by the service device 4. For instance, in the RFID embodiment described above, the service device 4 may send an interrogation signal 101 continuously or with sufficient periodicity so that an RFID proximity tag 34 may be interrogated within a substantially imperceptible short duration after entrance into the proximity zone PZi. Reception of the response communication 103 from the RFID proximity tag 34 would then inform the service device 4 of the presence of the tag 34 in the proximity zone. The response communication 103 may include the equipment identifier UID to allow identification of the user by the service device 4.

In response to the detection of user equipment 3 in the proximity zone PZi, a communication is established at step 302 between the service device 4 and the proximity tag 34 of user equipment 3. At step 304, service device 4 then transmits a tagging signal including the service identifier SIDi stored in the storage means 43 to the proximity tag 34, thereby activating the service identifier for the user. The proximity tag 34 may then store the received service identifier SIDi in the storage means 32.

The service device 4 could also send to the proximity tag 34 auxiliary information related to the service including, with no limitation: data related to the service like a service status indicator, service usage control information or availability data, and/or data generated for the user during the previous activation phase, like for instance a user sequence number or a timestamp. This auxiliary information will be used to decide whether to authorize or not access to the service, when the authorization token is computed. When the user equipment identifier UID is transmitted with the response signal 103, the nature of the auxiliary information may vary depending on the user equipment identifier. In FIG. 5, step 304 is performed subsequently to step 302. Alternatively, steps 302 and 304 could be performed substantially at the same time.

Service identifiers SID may thus be activated for a number of users located in proximity zones within the area Ak. After such an activation phase, the storage means 32 of a user equipment 3 will contain: prestored data related to the user, like the user equipment identifier UID, the data received from the service device 4, including the activated service identifier SID, and possibly the auxiliary information related to the service. One skilled in the art will readily recognize that, in certain applications of the invention, the storage means 32 could store more than one service identifiers written by respective services devices 4.

In FIG. 1, the user equipments 3 for which a service identifier has been activated are represented with a striped rectangle. Before, during, and after service identifier activation, a tagged user as well as the service support 48 associated to the requested service may be mobile in the area Ak. When one of these tagged users is detected in area Ak, access control is started to determine whether the user should be granted or denied access to the requested service. More specifically, when a user equipment is detected in the security sensitive area Ak, the location means 5 establish a wireless communication with the location tag 35 of the user equipment 3 service. The location tag 35 transmits user and service related data to the location means 5. In turn, the locations means 5 forward the service and user related data as well as computed location data to the processing unit 8 for computation of the authorization token.

As shown in FIG. 1, the location means 5 are indeed in communication via wireless or non-wireless connection 85 with the processing unit 8 for data exchange. The processing unit 8 may then transmit the computed authorization token to the user equipment 3, directly or indirectly via the location means 5.

The user will then have to submit the received authorization token to a service control device provided on the service support 48. The service control device will check the authorization token information to decide whether the user should be granted or denied access to the service, and may accordingly disable or enable a service locking mechanism.

Alternatively, the processing unit 8 could directly transmit the authorization token to the service control device provided on the service support 48. However, the following description will be made with reference to the embodiment where the authorization token is transmitted to the user equipment 3, for illustrative purposes.

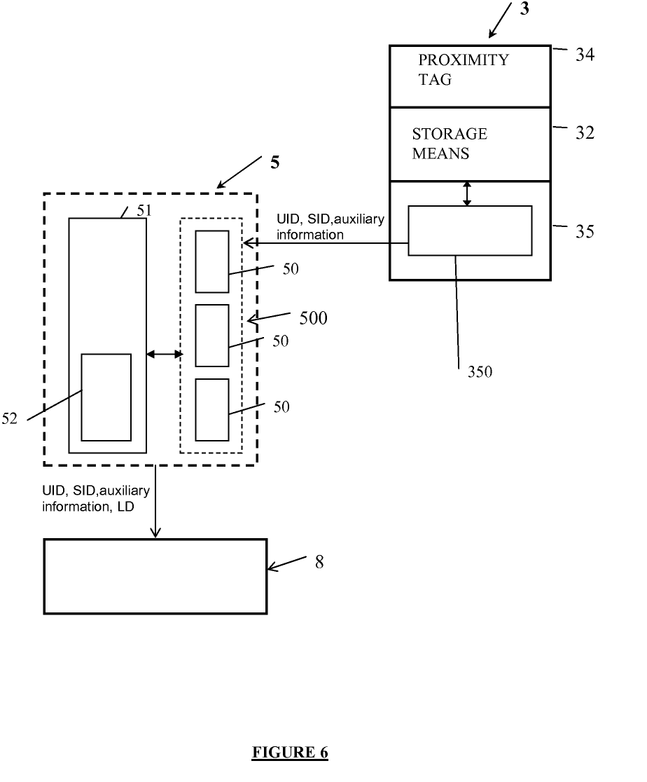

Reference is now made to the diagram of FIG. 6, representing the location means 5 in communication with a user equipment 3. As shown, the location means 5 are equipped with area communication means 500 covering the security sensitive area Ak. The area communication means 500 are provided to cover the desired area of control Ak.

The user location tag 35 comprises communication means 350 paired with the area communication means 500 of the location means 5 so that communication can be established between the location tag 35 and the location means 5. When a user equipment 3 is detected in the security sensitive area Ak, communication is established between the area communication means 500 and the communication means 350 of the location tag 35. The location means 5 then receive data from the location tag 35 including the equipment identifier UID, the activated service identifier SID, and possibly auxiliary information, like for instance a service status indicator, service usage information, availability data, a user sequence number and/or a timestamp. More specifically, the location tag 35 may retrieve these data from the shared storage means 32, prior to transmitting them to the location means 5.

The user equipment identifier UID was pre-stored in the storage means 32. The service identifier SID and the auxiliary information were stored in the storage means 32 by the proximity tag 35, upon reception of these data from a service device 4, during a previous activation phase. The auxiliary information comprises information generated for the user at the activation phase, like for instance the user sequence number or the timestamp.

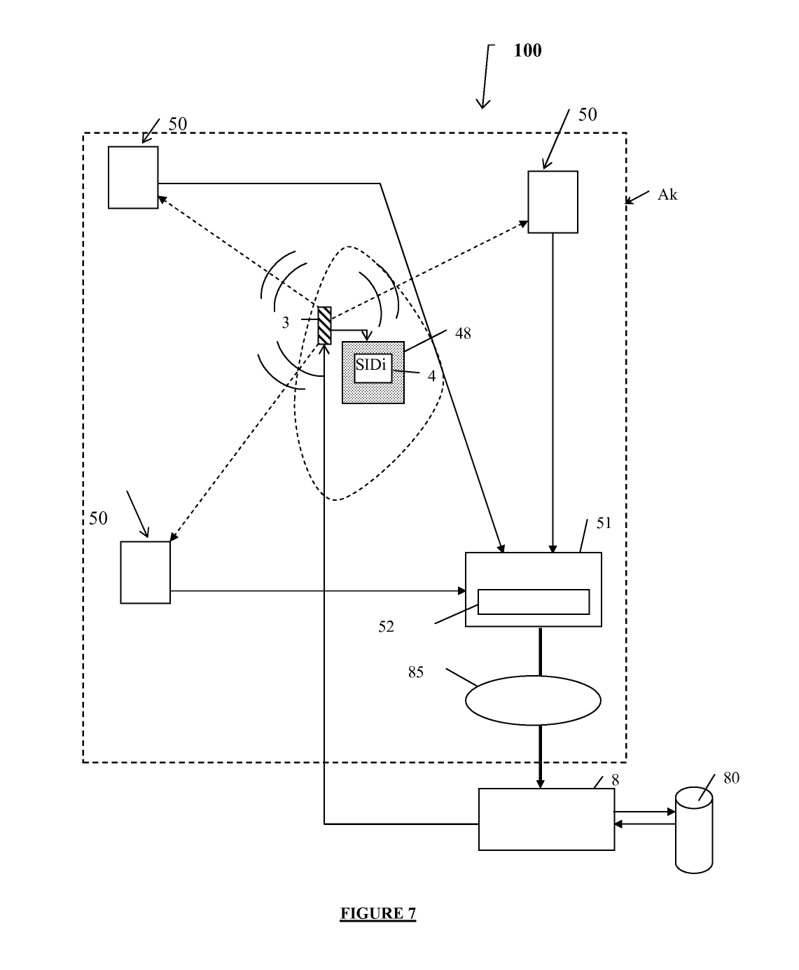

The location means 5 will in turn transmit the user identifier UID, the activated service identifier SID, and the other information received to the processing unit 8 through connection 85 as shown in FIG. 7. The location means 5 further computes location data LD and transmits them to the processing unit 8, through connection 85. The location data LD are related to the position of the user equipment 3 in area Ak. The location means 5 are arranged to calculate these location data, when the user equipment 3 is detected in area Ak.

FIGS. 6 and 7 illustrate a particular embodiment of the location means 5. In this embodiment, the area communication means 500 includes a grid of receivers 50, each adapted to communicate with the communication means 350 of the location tag 35. The location means 5 further comprises a reader 51 incorporating a calculator 52 that interact with the receivers 50. One skilled in the art will understand that FIG. 6 is a simplified functional representation of the location means 5, independent of the effective spatial configuration of the different components 51, 52, and 50.

FIG. 7 shows three receivers 50 arranged to cover the security sensitive area Ak. It is to be noted that only one service device 4 has been represented in FIG. 7 for more clarity although several service devices 4 may be available in area Ak. It should be further noted that the grid configuration shown in FIG. 7 is for illustrative purposes only and that other grid configurations could be used alternatively.

The location means 5 may be in particular of RFID type adapted for an RFID communication with the location tag 35. As illustrated in FIG. 7, each receiver 50 is in communication via wireless or non-wireless connection with reader 51. Each RFID receiver 50 is further capable of establishing a wireless communication with the location tag 35 of a user equipment 3, located in the security sensitive area Ak, though the area communication means.

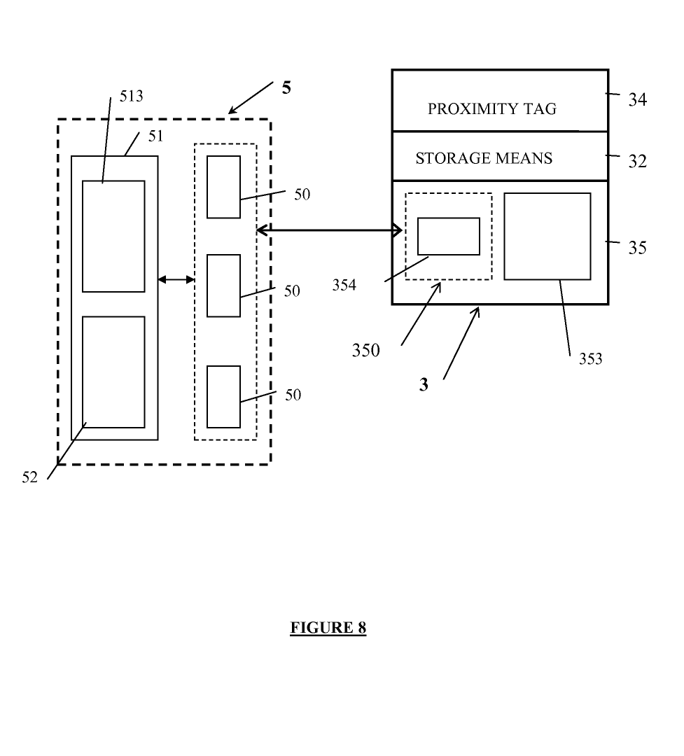

FIG. 8 illustrates the communication between the location means 5 and the location tag 35 of a user equipment 3, according to the RFID embodiment. The RFID location tag 35 includes a radio frequency integrated circuit 353 and the communication means 350. The communication means 350 include at least an antenna 354. The RFID reader 51 includes a RFID suitable circuitry 513. Each receiver 50 includes an antenna capable of bi-directional communication or coupling, according to a desired communication protocol, with location tag 35, when the tag 35 is in the area Ak.

The RFID circuitry 353 of location tag 35 is in particular “active”, i.e. capable of actively generating a response communication. Accordingly, tag 35 may include a battery or other suitable power supply (e.g. protocol) connected and supplying power to the RFID circuitry 353. The reader 51 may employ Ultra Wide-Band transmission (UWB) or alternatively WiFi transmission to cover area Ak.

The location tag 35 emits detection signals that may or may not contain data until they reach receivers 50 for communication. The transmission of the signals may be performed at a high repetition rate so as to substantially continuously monitor the vicinity of user equipment 3, and thereby reach the receivers 50. Alternatively, the emission of the signals from the tag may be performed at a low repetition rate. The signals from the tag 35 may be transmitted in all directions, or alternatively in specific directions, by using for example an antenna 354 of directional type.

To determine the location data LD, each RFID receivers 50 measures a parameter related to the path of the signals received from the location tag 35, like for instance the signal strength. Each receiver 50 then transmits the parameter measured to the calculator 52 which will compute location data LD from all the measures received.

The calculator 52 could use the measures received from the receivers 50 to calculate the distance between the RFID receivers and the RFID location tag 35 and derive the position of the user equipment from the computed distance as location data LD. The calculator 52 may for instance use the distances to the array of receivers 50 and the known location of the receivers 50 to determine the position of the user in the area, using known techniques like triangulation techniques. The calculator 52 will then transmit these location data LD to the processing unit 8 through connection 85.

It should be noted that the calculator 52 could be alternatively implemented in a variety of ways. For example, the calculator 52 could be separate from the reader 51. The calculator could also be fully integrated to the processing unit 8, the receivers 50 then transmitting the measures of the signal parameter (strength, phase, fundamental frequency data . . . ) to the processing unit 8 as location data. The calculator 52 could also be implemented partially in the reader 51, and partially at the processing unit 8.

The calculator 52 may use any suitable technique to determine the location data LD. The configuration of the receivers 50, their number, and the nature of the signal parameter vary depending on the technique used and on the application field of the invention.

The techniques that could be used include, with no limitation:

The TDoA technique that measures the difference in transmission times between signals received from each of the receivers 50 to the location tag 35.

The Angle of Arrival (AoA) technique that uses the positions of two receivers 50 at known locations, and determines the position of the location tag 35 using triangulation.

The Time of Arrival (ToA) technique that uses the measurement of the propagation delay of the radio signals exchanged between the location tag 35 and the receivers 50.

Received Signal Strength Indication (RSSI) technique that uses the signal strength of signals received from at least three receivers 50.

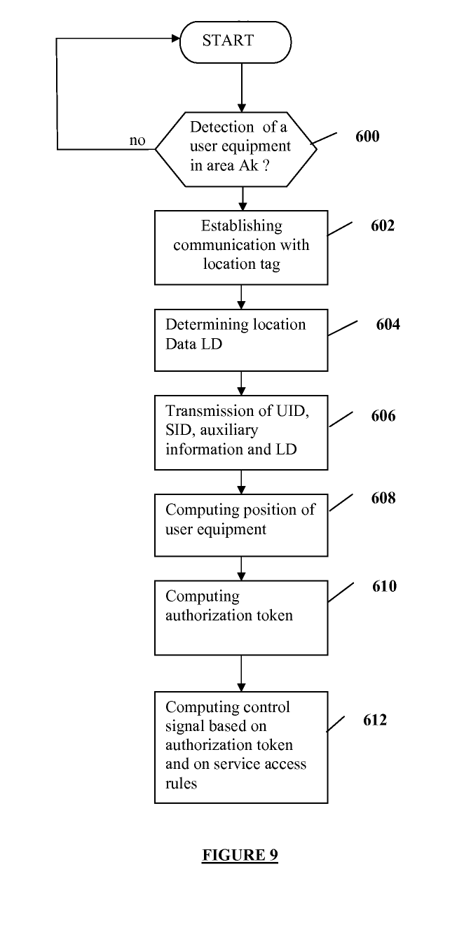

Reference is now made to the flowchart of FIG. 9 which shows the steps performed to control access to a service according to the invention. The access control process starts at step 600, with the detection of a user equipment 3 in the security sensitive area Ak. At step 602, communication is established between the location means 5 and the location tag 35. At step 604, the location means 5 determines location data LD.

At step 606, the location tag 35 transmits to the location means 5, through the established communication, the equipment identifier UID, the activated service identifier SID, the location data LD, and possibly the auxiliary information, like for instance a user sequence number or a time stamp.

This transmission of information could alternatively occur at step 602 or at a later step. Further, the identifier UID, the activated service identifier SID, the auxiliary information, and the location data could be transmitted separately.

The processing unit 8 uses the location data LD computed at step 608, the equipment identifier UID, the service identifier SID, and the auxiliary data, to compute the authorization token at step 610. The processing unit 8 then transmits the authorization token to the user equipment 3 directly, or alternatively via the location means 5, through the area communication means or other communication means. In particular, in the embodiment where the area communication means between the location tag 35 and the location means 5 are of UWB RFID type, the authorization token may be transmitted from the reader 51 to the user equipment 3 using radio communication means implemented in one of receiver 50 or in another additional device. The authorization token may be a list of parameters including: the user equipment identifier UID, the service identifier SID, an authorization value (for instance “yes”/“no”), and possibly, the auxiliary information.

On receiving the authorization token, the user equipment 3 will then have to submit it to the service control device provided on the service support 48. The service control device 48 will in turn compute a control signal at step 612 based on the authorization token and predefined service access rules. The control signal will be input to a locking mechanism to give or prohibit the user access to the service.

Prior to transmission of the authorization token to the service control device, the user equipment 3 could store it in the storage means 32. In a particular embodiment, the transfer of the authorization token from the user equipment 3 to the service control device is transparently triggered when the user equipment 3 is detected in the proximity zone of the service device 4 associated with the requested service. Communication is thus established between the proximity communication means 410 of the proximity tag 34 and the service device 4, for authorization token transfer.

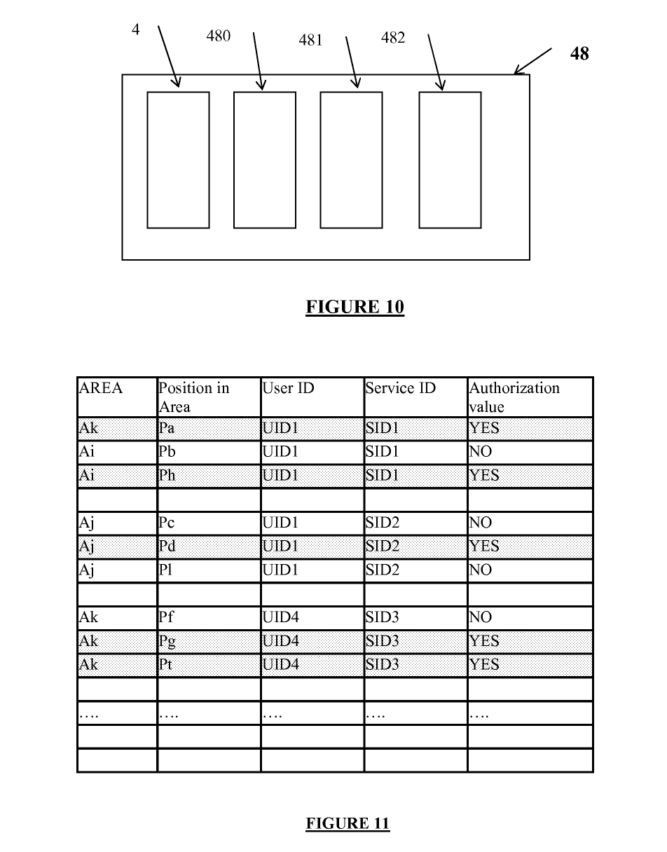

FIG. 10 illustrates an exemplary structure of the service support 48. As shown, the service support 48 is equipped with service storage means 480, a service control device 481, and a locking mechanism 482. The service storage means 480 stores the predefined service access rules and the authorization token when received.

The service control device 481 is coupled to the service storage means 480 and to the locking mechanism 482 and compute the control signal at step 612 of FIG. 9, based on the authorization token and the predefined access rules. The control signal will be input to the service locking mechanism 482. The control signal may correspond to a granting decision, in which case it will disable the locking mechanism 482 to allow access to the service, or conversely to a non-granting decision, in which case it will enable the locking mechanism 482 to prohibit access to the service.

The predefined access rules are related to the requested service. These rules may include access duration conditions, conditions on the maximum number of service accesses allowed per user, or conditions on other measurable quantities like the number of users simultaneously “requesting” access to the service or service usage.

The service access rules may also include control conditions on quantities such as the time delay between the time at which the access to the service was granted to a user and the time at which the user actually access to the service.

The service access rules may also checks whether, after reception of the authorization token by the user equipment, the user has effectively submitted it to the service control device 48 before expiration of a predefined time delay (by coming in close proximity to the service). Another service access rule could control whether the user equipment 3 has leaved the proximity zone for a duration longer than a reference duration, and if so causing service access denying. The user equipment will then have to restart an activation phase with the service device 4 to request access to the service again.

It should be noted that the control signal could be alternatively directly computed by the processing unit 8 or by a central service control device separated from the service support 48, and then sent to the service locking mechanism 482. In this alternative embodiment, the predefined access rules for each service could be stored at the level of the processing unit 8, for example in database 80, or at the level of the service control device.

Reference is now made to FIG. 9 representing a simplified example of an authorization table stored in database 80. The processing unit 8 uses such authorization table to compute the authorization token. As shown, the table defines combinations of parameters for which the access to the service should be granted (authorization value=“yes”) or denied (authorization value=“no”), subject to the verification of the service access rules. The parameters include the area identifier (e.g. Ak), the user position (e.g. Pa) in the area, the user equipment identifier (e.g. UID1), the service identifier SIDI and the authorization value (e.g. “yes”).

It will readily occur to one skilled in the art that the authorization table could take into account other parameters to define the combinations. One skilled in the art will also understand that the authorization table shown in FIG. 10 is a very simplified representation, and that other types of authorization tables of different and more complex structures could be used alternatively, including authorization tables in the form of a set of interrelated look-up tables.

The processing unit 8 will determine which combination of the authorization table is matched by the user equipment identifier UID, the service identifier SID, and the location data, received from the location means 5. The processing unit 8 will compute the authorization token based on the matched combination.

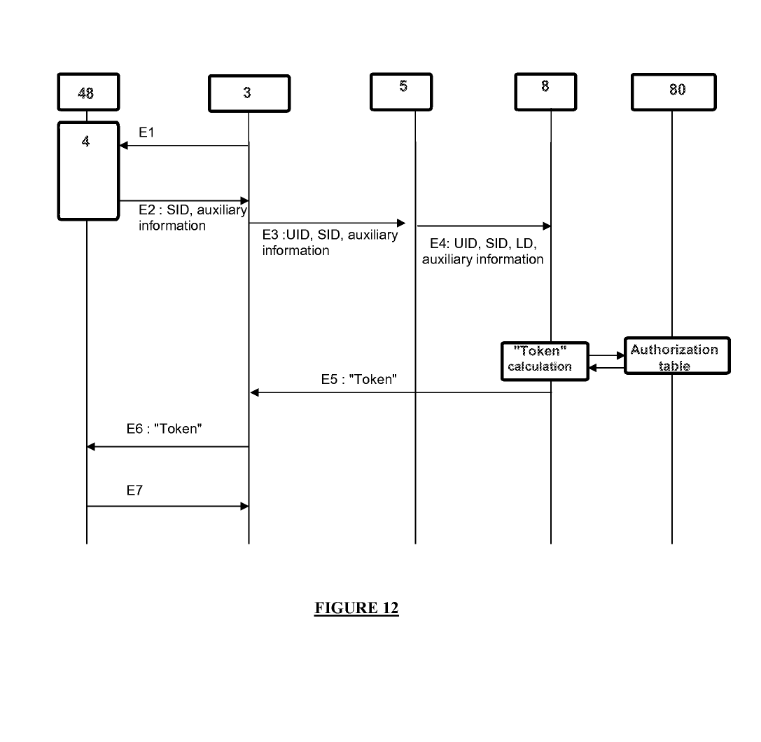

FIG. 12 shows the data exchanged between the components of system 100. FIG. 12 contains a number of reference signs E1 to E7 that refer to particular steps of the service access control. At E1, a user comes in close proximity to a particular service device 4 to request access to the corresponding service. This triggers activation of the service identifier.

At E2, the service device 4 writes the service identifier SID and possibly service information (user sequence number, service time stamp, authorization duration, service status . . . to the user equipment 3. At E3, the user equipment 3 sends the service identifier SID to location means 5, together with auxiliary information including user and service information.

At E4, the location means 5 sends location data LD, service identifier SID, as well as the auxiliary information to processing unit 8. At E5, processing unit 8 sends an authorisation token “Token” to user device 4, including user identifier, service identifier, authorization value and possibly some of the auxiliary information.

At E6, the user equipment 3 submits the authorisation token “Token” to service device 4. At E7, the service control device 481 generates a control signal based on the authorization token and on the predefined service access rules. The control signal will then be input to the locking mechanism to permit or prohibit access to the service.

As an example, in a pharmaceutical site where a service, consisting in opening a case containing contaminated material, is available in a confined area Ak, the locking mechanism 482 and the service control device 481 could be implemented as an electronic key device. To request access to the service (i.e. opening the case), the user will bring the user equipment 3, which form somewhat the key, in the proximity zone of the service device 4 attached to the case. In such example, the authorization token will be stored in the service storage means 480 and processed by the service control device 481 and then a control signal will be emitted from the service control device 481 to disable or enable a case locking mechanism 482.

The system 100 could further include deactivation means to deactivate a service identifier previously activated, upon granting or denying the user access to the corresponding service. Further, the location means 5 could be arranged to detect departure of a user equipment 3 from area Ak, after activation of a service identifier for that user, and automatically signal the departure to the processing unit 8, which then would initiate access control termination.

Embodiments of the invention thus make it possible for a user, equipped with a user equipment 3, to request access to a service, in a given area Ak, in a transparent and dynamic manner. The invention also provide an efficient service access control that not only takes into account the local conditions at the user position, but also the nature of the service required and the level of authorization of the user.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. For example, instead of using locking mechanisms such as 481 provided in the service support 48, system 100 could include alarm devices capable of activation by the control signal computed by the service control device 481. Such alarm devices could be implemented in the form of local alarms that generate a text message sent to the site security staff and/or generate a text message displayed to the user.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims. While the invention has been described in terms of several exemplary embodiments, those skilled in the art will recognize that the invention can be practiced with modification within the spirit and scope of the appended claims.

What is claimed is:

1. A system for controlling access to a plurality of services within an area, each service of the plurality of services being associated with a service identifier identifying the service, the system comprising:
at least one service device storing a service identifier for identifying a service among the plurality of services, each service device covering a proximity zone within the area and being capable of activating the service identifier stored by the service device for the user, in response to the detection of a user in the proximity zone; and
an access control subsystem to control the access of a user to a service identified by a service identifier activated for the user.

2. The system of claim 1, wherein each user is equipped with user equipment storing a user equipment identifier, the at least one service device being capable of activating the service identifier by tagging the user equipment with the service identifier.

3. The system of claim 2, wherein the access control subsystem comprises
location means to determine location data identifying the position of the user equipment within the area, in response to the detection of the user equipment within the area;
a processing unit, interacting with the location means, to compute an authorization token from the service identifier activated for the user, the user equipment identifier stored in the user equipment, and the location data determined by the location means.

4. The system of claim 3, wherein the authorization token includes the service identifier activated for the user, the equipment identifier identifying the user equipment, and an authorization value.

5. The system of any of claim 3, wherein the user is granted or denied access to the service based on the authorization token and at least one predefined service access rule.

6. The system of claim 2, wherein the at least one service device is equipped with proximity communication means covering the proximity zone within the area for communication with the user equipment located in the proximity zone and having communication means paired with the proximity communication means.

7. The system of claim 6, wherein the at least one service device is arranged to transmit the service identifier to the user equipment through the proximity communication means, thereby tagging the user equipment.

8. The system of claim 6, wherein said proximity communication means includes short-range radio frequency communication means.

9. The system of claim 6, wherein the proximity communication means includes RFID communication means and the service device comprises an RFID interrogator interacting with an RFID proximity tag in the user equipment.

10. The system of claim 9, wherein the proximity communication means use high frequency signaling.

11. The system of claim 9, wherein the proximity communication means includes passive type RFID communication means.

12. The system of claim 3, wherein the location means comprises area communication means covering the area for communication with the user equipment located in the area and having communication means paired with the area communication means.

13. The system of claim 12, wherein the area communication means includes short-range radio frequency communication means.

14. The system of claim 12, wherein the area communication means comprises a set of receivers arranged to cover the area.

15. The system of claim 14, wherein the area communication means includes RFID communication means, the location means includes an RFID reader capable of communicating with an RFID location tag included in the user equipment, through the set of receivers, and a calculator for computing the location data.

16. The system of claim 15, wherein the RFID area communication means uses at least one of: ultra-wide band signaling or WiFi signaling.

17. The system of claim 14, wherein the location data are derived from distances between each receiver and the user equipment.

18. The system of claim 3, wherein the processing unit uses at least one authorization table stored in a database to compute the authorization token.

19. A device for interacting with a system for controlling access to a plurality of services within an area, the device comprising:
storage means for storing a user equipment identifier and being capable of storing at least one service identifier received from a service device, in response to the activation of the service identifier by the service device.

20. A method for controlling access to a plurality of services within an area, each service of the plurality of services being associated with a service identifier identifying the service, the method comprising:
providing at least one service device for storing a service identifier identifying a service among the plurality of services, each service device covering a proximity zone within the area;
in response to the detection of a user in the proximity zone of a service device, activating the service identifier stored by the service device for the user; and
in response to a service identifier being activated for a user located in the area, controlling access of the user to the service identified by the activated service identifier.
